(19) United States
(12) Patent Application Publication
(10) Pub. No.: US 2024/0163744 A1
(43) Pub. Date: May 16, 2024

(54) SYSTEM AND METHOD OF CFRA RESOURCE CONFIGURATION FOR LOWER LAYER SIGNAL BASED MOBILITY

(71) Applicant: Samsung Electronics Co., Ltd., Suwon-si (KR)

(72) Inventors: Anil AGIWAL, Suwon-si (KR); Seungri JIN, Suwon-si (KR)

(21) Appl. No.: 18/500,523

(22) Filed: Nov. 2, 2023

(30) Foreign Application Priority Data
Nov. 3, 2022 (KR) 10-2022-0145382

(51) Int. Cl. H04W 36/00; H04W 74/08

(52) U.S. Cl. CPC H04W 36/0072; H04W 36/0058; H04W 74/0833

(57) ABSTRACT

A method performed by a user equipment (UE) in a wireless communication system is provided. The method includes receiving, from a base station of a serving cell, a radio resource control (RRC) reconfiguration message including a configuration of one or more candidate target cells associated with layer 1 (L1) or layer 2 (L2) triggered mobility (LTM), transmitting, to the base station, a RRC reconfiguration complete message, transmitting, to the base station, a report for a L1 measurement associated with the one or more candidate target cells, and receiving, from the base station, a cell switch command message associated with the LTM, via medium access control-control element (MAC-CE) signaling, the cell switch command message including random access information on a target cell.

### CROSS-REFERENCE TO RELATED APPLICATION(S)

This application is based on and claims priority under 35 U.S.C. § 119(a) of a Korean patent application number 10-2022-0145382, filed on Nov. 3, 2022, in the Korean Intellectual Property Office, the disclosure of which is incorporated by reference herein in its entirety.

### BACKGROUND

### 1. Field

The disclosure relates to a wireless communication system. More particularly, the disclosure relates to an apparatus, a method and a system for configurations associated with lower layer signal based mobility.

### 2. Description of Related Art

5th generation (5G) mobile communication technologies define broad frequency bands such that high transmission rates and new services are possible, and may be implemented not only in “Sub 6 gigahertz (GHz)” bands such as 3.5 GHz, but also in “Above 6 GHz” bands referred to as mmWave including 28 GHz and 39 GHz. In addition, it has been considered to implement 6th generation (6G) mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadband, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual Reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for supporting layer 1 (L1) or L2 triggered mobility (LTM) that is based on L1 measurements.

Another aspect of the disclosure is to provide a method for configurations associated with a random access procedure, when a UE performs the random access procedure triggered by the LTM.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station of a serving cell, a radio resource control (RRC) reconfiguration message including a configuration of one or more candidate target cells associated with layer 1 (L1) or L2 triggered mobility (LTM), transmitting, to the base station, a RRC reconfiguration complete message, transmitting, to the base station, a report for a L1 measurement associated with the one or more candidate target cells, and receiving, from the base station, a cell switch command message associated with the LTM, via medium access control-control element (MAC-CE) signaling, wherein the cell switch command message includes random access information on a target cell.

In accordance with another aspect of the disclosure, a method performed by a base station of a source cell in a wireless communication system is provided. The method includes transmitting, to a UE, a RRC reconfiguration message including a configuration of one or more candidate target cells associated with LTM, receiving, from the UE, a RRC reconfiguration complete message, receiving, from the UE, a report for a L1 measurement associated with the one or more candidate target cells, and transmitting, to the UE, a cell switch command message associated with the LTM, via MAC-CE signaling, wherein the cell switch command message includes random access information on a target cell.

In accordance with another aspect of the disclosure, a UE in a wireless communication system is provided. The UE includes a transceiver, and a processor coupled with the transceiver and configured to receive, from a base station of a serving cell, a RRC reconfiguration message including a configuration of one or more candidate target cells associated with LTM, transmit, to the base station, a RRC reconfiguration complete message, transmit, to the base station, a report for a L1 measurement associated with the one or more candidate target cells, and receive, from the base station, a cell switch command message associated with the LTM, via MAC-CE signaling, wherein the cell switch command message includes random access information on a target cell.

In accordance with another aspect of the disclosure, a base station in a wireless communication system is provided. The base station includes a transceiver, and a processor coupled with the transceiver and configured to transmit, to a UE, a RRC reconfiguration message including a configuration of one or more candidate target cells associated with LTM, receive, from the UE, a RRC reconfiguration complete message, receive, from the UE, a report for a L1 measurement associated with the one or more candidate target cells, and transmit, to the UE, a cell switch command message associated with the LTM, via MAC-CE signaling, wherein the cell switch command message includes random access information on a target cell.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates inter-gNB handover procedures in a wireless communication system according to an embodiment of the disclosure;

FIG. 2 illustrates lower layer based mobility procedures according to an embodiment of the disclosure;

FIG. 3 illustrates a block diagram of a UE according to an embodiment of the disclosure; and

FIG. 4 illustrates a block diagram of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

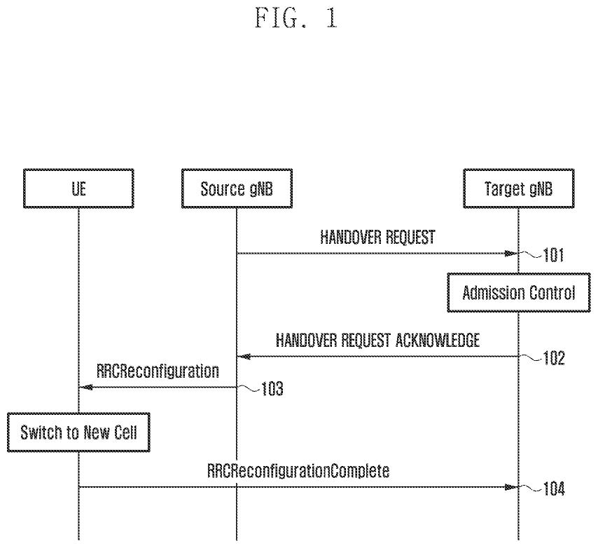

FIGS. 1 through 4, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

Embodiments of the disclosure are described with reference to the accompanying drawings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

In the following description, a BS is an entity that allocates resources to terminals, and may be at least one of a gNode B, an eNode B, a Node B, a BS, a wireless access unit, a BS controller, and a node on a network. A terminal may include a UE, a mobile station (MS), a cellular phone, a smartphone, a computer, or a multimedia system capable of performing communication functions.

In the recent years, several broadband wireless technologies have been developed to meet the growing number of broadband subscribers and to provide more and better applications and services. The second-generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive MIMO, FD-MIMO, array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility, etc. However, it is expected that the design of the air-interface of the fifth generation wireless communication system would be flexible enough to serve the UEs having quite different capabilities depending on the use case and market segment the UE cater service to the end customer.

Few example use cases the fifth generation wireless communication system wireless system is expected to address is an eMBB, a mMTC, a URLLC, etc. The eMBB requirements like tens of Gbps data rate, low latency, high mobility so on and so forth address the market segment representing the conventional wireless broadband subscribers needing internet connectivity everywhere, all the time and on the go. The mMTC requirements like very high connection density, infrequent data transmission, very long battery life, low mobility address so on and so forth address the market segment representing the Internet of Things (IoT)/Internet of Everything (IoE) envisioning connectivity of billions of devices. The URLLC requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system, operating in higher frequency (e.g., mmWave) bands, the UE and a next generation node B (gNB) communicate with each other using beamforming. Beamforming techniques are used to mitigate the propagation path losses and to increase the propagation distance for communication at higher frequency band. Beamforming enhances the transmission (TX) and reception (RX) performance using a high-gain antenna. Beamforming can be classified into TX beamforming performed in a transmitting end and RX beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on an RX signal by using an RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as RX beam.

The fifth generation wireless communication system supports standalone mode of operation as well dual connectivity (DC). In DC, a multiple Rx/Tx UE may be configured to utilize resources provided by two different nodes (or NBs) connected via non-ideal backhaul. One node acts as a master node (MN) and the other as a secondary node (SN). The MN and SN are connected via a network interface and at least the MN is connected to the core network. NR also supports multi-RAT dual connectivity (MR-DC) operation whereby a UE in RRC_CONNECTED is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in RRC_CONNECTED not configured with CA/DC, there is only one serving cell comprising of the primary cell. For a UE in RRC_CONNECTED configured with CA/DC the term ‘serving cells’ is used to denote the set of cells comprising of the special cell(s) (SpCell(s)) and all secondary cells. In NR the term master cell group (MCG) refers to a group of serving cells associated with the MN, comprising of the primary cell (PCell) and optionally one or more secondary cells (SCells). In NR the term secondary cell group (SCG) refers to a group of serving cells associated with the SN, comprising of the primary SCG cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, SCell is a cell providing additional radio resources on top of SpCell. PSCell refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term SpCell refers to the PCell.

Physical Downlink Control Channel (PDCCH) in Fifth Generation Wireless Communication System

In the fifth generation wireless communication system, PDCCH is used to schedule downlink (DL) transmissions on a physical downlink shared channel (PDSCH) and uplink (UL) transmissions on a physical uplink shared channel (PUSCH), where the downlink control information (DCI) on PDCCH includes: Downlink assignments containing at least modulation and coding format, resource allocation, and hybrid-automatic repeat request (HARQ) information related to downlink shared channel (DL-SCH); UL scheduling grants containing at least modulation and coding format, resource allocation, and HARQ information related to uplink shared channel (UL-SCH). In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and OFDM symbol(s) where the UE may assume no transmission is intended for the UE; Transmission of transmit power control (TPC) commands for physical uplink control channel (PUCCH) and PUSCH; Transmission of one or more TPC commands for sounding reference signal (SRS) transmissions by one or more UEs; Switching a UE's active bandwidth part; Initiating a random access procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units resource element groups (REGs) and control channel elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations is signaled by the gNB for each configured BWP wherein each search space configuration is uniquely identified by an identifier. Identifier of search space configuration to be used for specific purpose such as paging reception, system information (SI) reception, random access response reception is explicitly signaled by the gNB. In NR, search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x−Monitoring-offset-PDCCH-slot)mod (Monitoring-periodicity-PDCCH-slot)=0; Equation 1

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations is signaled by the gNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported subcarrier spacing (SCS) is pre-defined in NR.

Each coreset configuration is associated with a list of transmission configuration indicator (TCI) states. One DL reference signal (RS) identity (ID) (e.g., synchronization signal block (SSB) or channel state information reference signal (CSI RS)) is configured the per TCI state. The list of TCI states corresponding to a coreset configuration is signaled by the gNB via radio resource control (RRC) signaling. One of the TCI state in TCI state list is activated and indicated to the UE by the gNB via medium access control-control element (MAC-CE). TCI state indicates the DL TX beam (DL TX beam is quasi-co-located (QCLed) with SSB/CSI RS of TCI state) used by the gNB for transmission of PDCCH in the PDCCH monitoring occasions of a search space. For the PDSCH, the TCI state of scheduling PDCCH may be used for the scheduled PDSCH. Alternately, TCI state of the PDCCH for the lowest corset ID in the slot is used for PDSCH. Alternately combination of RRC+MAC CE+DCI is used to indicate the TCI state for the PDSCH. The RRC configures a list of TCI state, the MAC CE indicates a subset of these TCI states and the DCI indicates one of the TCI state from list of the TCI states indicated in the MAC CE.

Bandwidth Adaptation (BA) in Fifth Generation Wireless Communication System

In fifth generation wireless communication system, the BA is supported. With BA, the receive and transmit bandwidths of a UE need not be as large as the bandwidth of the cell and can be adjusted: the width may be ordered to change (e.g., to shrink during period of low activity to save power); the location may move in the frequency domain (e.g., to increase scheduling flexibility); and the subcarrier spacing may be ordered to change (e.g., to allow different services). A subset of the total cell bandwidth of a cell is referred to as a BWP. BA is achieved by configuring the RRC connected UE with BWP(s) and telling the UE which of the configured BWPs is currently the active one. When the BA is configured, the UE only has to monitor the PDCCH on the one active BWP, i.e., it does not have to monitor PDCCH on the entire DL frequency of the serving cell. In RRC connected state, the UE is configured with one or more DL and UL BWPs, for each configured serving cell (i.e., PCell or SCell). For an activated serving cell, there is always one active UL and DL BWP at any point in time.

The BWP switching for a serving cell is used to activate an inactive BWP and deactivate an active BWP at a time. The BWP switching is controlled by the PDCCH indicating a downlink assignment or an UL grant, by the bwp-InactivityTimer, by RRC signaling, or by the medium access control (MAC) entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an UL grant. The active BWP for a serving cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random Access (RA) in Fifth Generation Wireless Communication System

In the 5G wireless communication system, the RA is supported. The RA is used to achieve UL time synchronization. RA is used during initial access, handover, RRC connection re-establishment procedure, scheduling request (SR) transmission, SCG addition/modification, beam failure recovery (BFR) and data or control information transmission in UL by non-synchronized UE in RRC CONNECTED state. Several types of random access procedure is supported.

Contention Based Random Access (CBRA):

This is also referred as 4 step CBRA. In this type of random access, the UE first transmits random access preamble (also referred as message1 (Msg1)) and then waits for random access response (RAR) in the RAR window. RAR is also referred as message2 (Msg2). A gNB transmits the RAR on PDSCH. PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission occasion or RA channel (RACH) occasion) in which RA preamble was detected by the gNB. The RA-RNTI is calculated as follows: RA−RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various random access preambles detected by the gNB can be multiplexed in the same RAR MAC protocol data unit (PDU) by the gNB. An RAR in MAC PDU corresponds to the UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by the gNB in RACH configuration) number of times, the UE goes back to first step i.e., select random access resource (preamble/RACH occasion (RO)) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, SR, SI request, etc. It may include the UE identity (i.e., cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a PDCCH addressed to C-RNTI included in Msg3, contention resolution is considered successful, contention resolution timer is stopped and RA procedure is completed. While the contention resolution timer is running, if UE receives contention resolution MAC CE including the UE's contention resolution identity (first X bits of common control channel (CCCH) service data unit (SDU) transmitted in Msg3), contention resolution is considered successful, contention resolution timer is stopped and the RA procedure is completed. If the contention resolution timer expires and the UE has not yet transmitted the RA preamble for a configurable number of times, the UE goes back to first step i.e., select random access resource (preamble/RACH occasion) and transmits the RA preamble. A backoff may be applied before going back to first step.

Contention Free Random Access (CFRA):

This is also referred as legacy CFRA or 4 step CFRA. The CFRA procedure is used for scenarios such as handover where low latency is required, timing advance establishment for SCell, etc. Evolved node B (eNB) assigns to the UE dedicated random access preamble. The UE transmits the dedicated RA preamble. The ENB transmits the RAR on PDSCH addressed to the RA-RNTI. The RAR conveys RA preamble identifier and timing alignment information. The RAR may also include UL grant. The RAR is transmitted in the RAR window similar to CBRA procedure. The CFRA is considered successfully completed after receiving the RAR including RA preamble identifier (RAPID) of RA preamble transmitted by the UE. In case the RA is initiated for BFR, the CFRA is considered successfully completed if the PDCCH addressed to the C-RNTI is received in search space for the BFR. If the RAR window expires and the RA is not successfully completed and the UE has not yet transmitted the RA preamble for a configurable (configured by the gNB in RACH configuration) number of times, the UE retransmits the RA preamble.

For certain events such as handover and BFR if dedicated preamble(s) are assigned to the UE, during first step of random access i.e., during random access resource selection for Msg1 transmission UE determines whether to transmit dedicated preamble or non-dedicated preamble. Dedicated preambles is typically provided for a subset of SSBs/CSI RSs. If there is no SSB/CSI RS having DL reference signal received power (RSRP) above a threshold amongst the SSBs/CSI RSs for which contention free random access resources (i.e., dedicated preambles/Ros) are provided by the gNB, the UE select non dedicated preamble. Otherwise, the UE selects a dedicated preamble. So during the RA procedure, one random access attempt can be CFRA while other random access attempt can be CBRA.

2 step contention based random access (2 step CBRA):

In the first step, the UE transmits random access preamble on PRACH and a payload (i.e., MAC PDU) on PUSCH. The random access preamble and payload transmission is also referred as message A (MsgA). In the second step, after MsgA transmission, the UE monitors for a response from the network (i.e., gNB) within a configured window. The response is also referred as message B (MsgB). The gNB transmits the MsgB on a PDSCH. The PDCCH scheduling the PDSCH carrying MsgB is addressed to MsgB-radio network temporary identifier (MSGB-RNTI). MSGB-RNTI identifies the time-frequency resource (also referred as PRACH occasion or PRACH TX occasion or RACH occasion) in which RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier.

If CCCH SDU was transmitted in MsgA payload, the UE performs contention resolution using the contention resolution information in the MsgB. The contention resolution is successful if the contention resolution identity received in the MsgB matches first 48 bits of CCCH SDU transmitted in MsgA. If C-RNTI was transmitted in the MsgA payload, the contention resolution is successful if the UE receives the PDCCH addressed to C-RNTI. If contention resolution is successful, random access procedure is considered successfully completed. Instead of contention resolution information corresponding to the transmitted MsgA, the MsgB may include a fallback information corresponding to the random access preamble transmitted in MsgA. If the fallback information is received, the UE transmits Msg3 and performs contention resolution using Msg4 as in CBRA procedure. If contention resolution is successful, random access procedure is considered successfully completed. If contention resolution fails upon fallback (i.e., upon transmitting Msg3), the UE retransmits MsgA. If configured window in which the UE monitor network response after transmitting the MsgA expires and the UE has not received the MsgB including contention resolution information or fallback information as explained above, the UE retransmits MsgA. If the random access procedure is not successfully completed even after transmitting the msgA configurable number of times, the UE fallbacks to 4 step RACH procedure, i.e., the UE only transmits the PRACH preamble.

The MsgA payload may include one or more of CCCH SDU, dedicated control channel (DCCH) SDU, dedicated traffic channel (DTCH) SDU, buffer status report (BSR) MAC CE, power headroom report (PHR) MAC CE, SSB information, C-RNTI MAC CE, or padding.

The MsgA may include UE ID (e.g., random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID may be one of random ID, S-TMSI, C-RNTI, resume ID, IMSI, idle mode ID, inactive mode ID, etc. The UE ID may be different in different scenarios in which UE performs the RA procedure. When the UE performs the RA after power on (before it is attached to the network), then the UE ID is the random ID. When the UE performs RA in IDLE state after it is attached to network, the UE ID is S-TMSI. If the UE has an assigned C-RNTI (e.g., in connected state), the UE ID is C-RNTI. In case the UE is in INACTIVE state, the UE ID is resume ID.

In addition to the UE ID, some addition control information may be sent in MsgA. The control information may be included in the MAC PDU of the MsgA. The control information may include one or more of connection request indication, connection resume request indication, SI request indication, buffer status indication, beam information (e.g., one or more DL TX beam ID(s) or SSB ID(s)), BFR indication/information, data indicator, cell/BS/TRP switching indication, connection re-establishment indication, reconfiguration complete or handover complete message, etc.

2 step contention free random access (2 step CFRA):

In this case the gNB assigns to the UE dedicated random access preamble (s) and PUSCH resource(s) for MsgA transmission. The RO(s) to be used for preamble transmission may also be indicated. In the first step, the UE transmits random access preamble on PRACH and a payload on PUSCH using the contention free random access resources (i.e., dedicated preamble/PUSCH resource/RO). In the second step, after MsgA transmission, the UE monitors for a response from the network (i.e., the gNB) within a configured window. The response is also referred as the MsgB.

The gNB transmits the MsgB on a PDSCH. PDCCH scheduling the PDSCH carrying MsgB is addressed to MSGB-RNTI. MSGB-RNTI identifies the time-frequency resource (also referred as PRACH occasion or PRACH TX occasion or RACH occasion) in which RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier.

If the UE receives PDCCH addressed to C-RNTI, random access procedure is considered successfully completed. If the UE receives fallback information corresponding to its transmitted preamble, random access procedure is considered successfully completed.

For certain events such as handover and BFR if dedicated preamble(s) and PUSCH resource(s) are assigned to the UE, during first step of random access i.e., during random access resource selection for MsgA transmission UE determines whether to transmit dedicated preamble or non-dedicated preamble. Dedicated preambles is typically provided for a subset of SSBs/CSI RSs. If there is no SSB/CSI RS having DL RSRP above a threshold amongst the SSBs/CSI RSs for which contention free random access resources (i.e., dedicated preambles/ROs/PUSCH resources) are provided by the gNB, the UE selects non dedicated preamble. Otherwise, the UE selects a dedicated preamble. So during the RA procedure, one random access attempt may be 2 step CFRA while other random access attempt can be 2 step CBRA.

Upon initiation of random access procedure, the UE first selects the carrier (SUL or NUL). If the carrier to use for the random-access procedure is explicitly signaled by the gNB, the UE selects the signaled carrier for performing random access procedure. If the carrier to use for the random-access procedure is not explicitly signaled by the gNB; and if the serving cell for the random access procedure is configured with SUL and if the RSRP of the downlink pathloss reference is less than rsrp-ThresholdSSB-SUL: the UE selects the SUL carrier for performing random access procedure. Otherwise, the UE selects the NUL carrier for performing random access procedure. Upon selecting the UL carrier, the UE determines the UL and DL BWP for random access procedure as specified in section 5.15 of TS 38.321. The UE then determines whether to perform 2 step or 4 step RACH for this random access procedure.
If this random access procedure is initiated by the PDCCH order and if the ra-PreambleIndex explicitly provided by PDCCH is not Ob000000, the UE selects 4 step RACH.
else if 2 step contention free random access resources are signaled by the gNB for this random access procedure, the UE selects 2 step RACH.
else if 4 step contention free random access resources are signaled by the gNB for this random access procedure, the UE selects 4 step RACH.
else if the UL BWP selected for this random access procedure is configured with only 2 step RACH resources, the UE selects 2 step RACH.
else if the UL BWP selected for this random access procedure is configured with only 4 step RACH resources, the UE selects 4 step RACH.
else if the UL BWP selected for this random access procedure is configured with both 2 step and 4 step RACH resources,
   if RSRP of the downlink pathloss reference is below a configured threshold, the UE selects 4 step RACH. Otherwise, the UE selects 2 step RACH.

Mobility in Fifth Generation Wireless Communication System:

There are two types of mobility, cell level mobility and beam level mobility.

Cell level mobility requires explicit RRC signaling to be triggered, i.e., handover. For inter-gNB handover, the signaling procedures consist of at least the following elemental components as shown in FIG. 1.

FIG. 1 illustrates inter-gNB handover procedures in a wireless communication system according to an embodiment of the disclosure.

Referring to FIG. 1, in operation 101, the source gNB initiates handover and issues a HANDOVER REQUEST over the Xn interface. The source gNB transmits the HANDOVER REQUEST message to a target gNB.

In operation 102, the target gNB performs admission control and provides the new RRC configuration as part of the HANDOVER REQUEST ACKNOWLEDGE. The target gNB transmits the HANDOVER REQUEST ACKNOWLEDGE message to the source gNB.

In operation 103, the source gNB provides the RRC configuration to the UE by forwarding the RRCReconfiguration message received in the HANDOVER REQUEST ACKNOWLEDGE. The RRCReconfiguration message includes at least cell ID and all information required to access the target cell so that the UE can access the target cell without reading system information. For some cases, the information required for contention-based and contention-free random access can be included in the RRCReconfiguration message. The access information to the target cell may include beam specific information, if any.

In operation 104, the UE moves the RRC connection to the target gNB and replies with the RRCReconfigurationComplete.

Several types of handover, e.g., normal handover, conditional handover and DAPS handover are supported.

Beam level mobility does not require explicit RRC signaling to be triggered. The gNB provides for serving cell via RRC signaling the UE with measurement configuration containing configurations of SSB/CSI resources and resource sets, reports and trigger states for triggering channel and interference measurements and reports. Beam level mobility is then dealt with at lower layers by means of physical layer and MAC layer control signaling, and RRC is not required to know which beam is being used at a given point in time. Based on physical layer and MAC layer control signaling, the UE may be switched from one beam to another in serving cell.

Lower Layer Mobility:

A new type of lower layer mobility also referred as layer 1 (L1)/layer 2 (L2)-triggered mobility (LTM) is being investigated. The Lower layer mobility is based on L1 measurements that are provided by the UE to the serving cell. Based on these measurements handover is triggered by sending L1 (e.g., DCI) or L2 (e.g., MAC CE) command. In lower layer mobility, the serving cell change is triggered based on Li beam measurements instead of L3 cell power and quality measurements that are configured in NR baseline handover of Rel. 15. L3 cell quality measurements are reported only after some Time-to-Trigger (TTT) expires for a measurement event. L3 measurements also filtered based on L3 configuration over multiple measurements before reporting. L1 measurements have the benefit that the network can react faster to radio link degradation in the serving link as the network may save the delay introduced by L3 filtering and TTT for the handover decision. This should result in reducing in the number of radio link failures compared to baseline handover.

In the legacy handover, RRC procedure delay consists of RRC signal processing related to decoding of handover command and L2/3 reconfiguration of the protocol layers. For lower layer mobility, RRC procedure delay may be reduced given that the UE may receive and decode the configuration of the target cells before the cell change occurs. Moreover, since lower layer mobility is restricted to intra-centralized unit (CU) scenario with same packet data convergence protocol (PDCP) and RRC, L2/3 reconfigurations may be minimized by keeping the same configuration for PDCP and RRC and possibly other layers such as radio link control (RLC) and MAC in intra-distributed unit (DU) scenario, i.e., in inter-DU scenario the new target cell may have differ configurations for RLC and MAC. In the best case for intra-DU, the target cell can reconfigure only the new C-RNTI which can save the entire L2/3 reconfiguration for the UE.

In legacy handover there is delay due to RF/baseband retuning, derivation of the target gNB security keys and configuration of the security algorithm to be used in the target cell. These may also be avoided in lower layer mobility. Given that the PDCP entity in the CU is the same for both source and target cells, the same security keys and algorithms can be applied which reduces the interruption time.

In the legacy handover there is interruption due to uncertainty in acquiring the first available PRACH occasion in the new cell. In addition, there are the interruptions of sending PRACH preamble and receiving the RACH response (RAR). These random access related interruption components can be reduced in lower layer mobility by introducing RACH-less handover where the UE skips the entire random-access procedure to the target cell. For scenarios where RACH-less cannot be applied, the UE can acquire the timing advance of the prepared target cells before the actual handover occurs.

CFRA may be supported for L1/L2 based mobility. The issue is how to configure CFRA resource for L1/L2 based mobility.

### Method 1

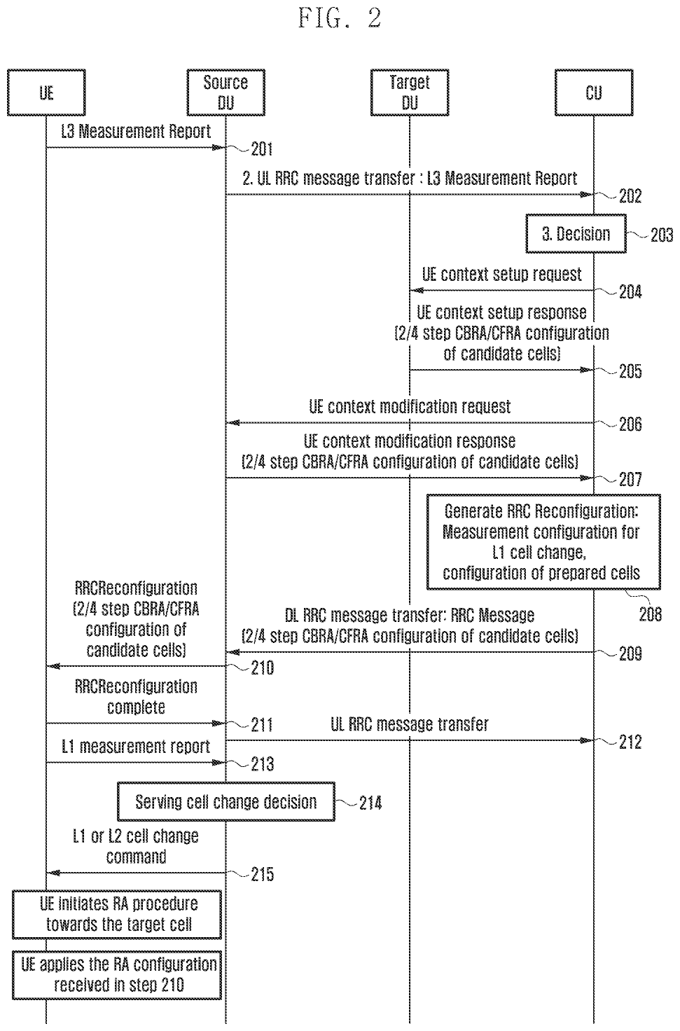

FIG. 2 illustrates lower layer based mobility procedures according to an embodiment of the disclosure. Orders of the operations in FIG. 2 may be changed. Further, some steps in FIG. 2 may be omitted or two or more steps may be combined to perform.

Referring to FIG. 2, in operation 201, the UE may send measurement report(s) containing the measurements of serving cell and target cell(s). Measurement report may be sent to the serving cell (e.g., source DU of the serving cell). In operation 202, source DU of the serving cell then may forward the measurement report to CU. The measurement report may be based on L3 measurements or L1 measurements.

In operation 203, based on the reported measurements, the CU may identify a potential set of candidate target cells to which the UE may be handed over. In this example, the CU may identify candidate target cells that are served by either source DU or another DU (i.e., target DU) which are controlled by the same CU.

In operation 204, the CU may request the preparation of a candidate target cell controlled by the target DU by sending UE Context Setup Request message to the target DU.

In operation 205, the target DU may provide the configuration of the UE in UE Context Setup Response messages, respectively, containing a container from DU to CU. The configuration may contain UE-specific parts and non-UE-specific parts.

Note that operations 204 and 205 may be not performed if candidate target cells of other DU are not identified in operation 203.

The configuration may include 4 step RA configuration (rach-ConfigCommon) and/or 2 step RA configuration (msgA-ConfigCommon). These RA configurations of candidate target cell are BWP specific and may be included in the respective BWP configuration of that candidate target cell. The configuration may be included in the UE Context Setup Response messages.

Rach-ConfigCommon indicates prach-ConfigurationIndex which is used to identify the PRACH occasions in time domain. Rach-ConfigCommon indicates msg1-FDM (The number of PRACH transmission occasions FDMed in one time instance) and msg1-FrequencyStart (Offset of lowest PRACH transmission occasion in frequency domain with respective to PRB 0) to identify the PRACH occasions in frequency domain. Rach-ConfigCommon also indicates other parameters such as preambleReceivedTargetPower, preambleTransMax, powerRampingStep, ra-ResponseWindow, ra-ContentionResolutionTimer, rsrp-ThresholdSSB, rsrp-ThresholdSSBSUL, preamble group B configuration, msg1-SubcarrierSpacing and ssb-perRACH-OccasionAndCB-PreamblesPerSSB. Rach-ConfigCommon may include RA Prioritisation parameters (powerRampingStepHighPriority and scalingFactorBI) to be applied for 4 step RA initiated towards the cell upon LiL2 cell change/switch command.

MsgA-ConfigCommon includes configuration of cell-specific MsgA PUSCH parameters such as MsgA PUSCH resources (msgA-PUSCH-ResourceGroupA) that the UE shall use when performing MsgA transmission using preambles group A, a PUSCH resources (msgA-PUSCH-ResourceGroupB) that the UE shall use when performing MsgA transmission using preambles group B. MsgA-ConfigCommon indicates msgA-PRACH-ConfigurationIndex which is used to identify the PRACH occasions in time domain. MsgA-ConfigCommon indicates msgA-RO-FDM (The number of PRACH transmission occasions FDMed in one time instance) and msgA-RO-FrequencyStart (Offset of lowest PRACH transmission occasion in frequency domain with respective to PRB 0) to identify the PRACH occasions in frequency domain. MsgA-ConfigCommon also indicates other parameters such as msgA-PreambleReceivedTargetPower, preambleTransMax, msgA-TransMax, msgA-PreamblePowerRampingStep, msgB-ResponseWindow, ra-ContentionResolutionTimer, msgA-RSRP-ThresholdSSB, preamble group B configuration, msgA-SubcarrierSpacing and msgA-SSB-PerRACH-OccasionAndCB-PreamblesPerSSB. MsgA-ConfigCommon may include RA Prioritisation parameters (powerRampingStepHighPriority and scalingFactorBI) to be applied for 4 step RA initiated towards the cell upon L1L2 cell change/switch command.

The candidate target cell configuration of SpCell (that may be included in the UE Context Setup Response messages) may include dedicated RA configuration (rach-ConfigDedicated for CFRA) for SUL and/or dedicated RA configuration (rach-ConfigDedicated) NUL to be applied for RA initiated towards the cell upon L1L2 cell change/switch command indicating switching to the cell. The rach-ConfigDedicated may include RA Prioritisation parameters (powerRampingStepHighPriority and scalingFactorBI) to be applied for 4 step RA. The rach-ConfigDedicated may include RA Prioritisation parameters (powerRampingStepHighPriority and scalingFactorBI) to be applied for 2 step RA.

The rach-ConfigDedicated may include 4 step RA parameters such as prach-ConfigurationIndex, msg1-FDM, msg1-FrequencyStart to identify the PRACH occasions and other parameters such as preambleReceivedTargetPower, preambleTransMax, powerRampingStep, ra-ResponseWindow. For 4 step RA, rach-ConfigDedicated may include list of one or more {SSB index and RA preamble index to use in the RA occasions associated with this SSB} and/or list of one or more {CSI RS index, RA preamble index to use in the RA occasions associated with this CSI-RS and a list of RACH occasions for this CSI RS}. For 4 step RA, rach-ConfigDedicated may include ra-ssb-OccasionMaskIndex which indicates a subset of RACH occasions per SSB which can be used amongst the RACH occasions for 4 step RA.

The rach-ConfigDedicated may include 2 step RA parameters such as msgA-PRACH-ConfigurationIndex, msgA-RO-FDM, msgA-RO-FrequencyStart to identify the PRACH occasions and other parameters such as msgA-PreambleReceivedTargetPower, preambleTransMax, powerRampingStep, msgB-ResponseWindow. For 2 step RA, rach-ConfigDedicated may include MsgA PUSCH resources (msgA-CFRA-PUSCH) that the UE shall use when performing MsgA transmission for CFRA. For 2 step RA, rach-ConfigDedicated may include list of one or more {SSB index, RA preamble index to use in the RA occasions associated with this SSB, PUSCH resource index (msgA-PUSCH-Resource-Index) of PUSCH resource to be used for this SSB} and/or list of one or more {CSI RS index, RA preamble index and PUSCH resource index (msgA-PUSCH-Resource-Index) of PUSCH resource to be used for this SSB}. The PUSCH resource index indicates a valid PUSCH occasion and the associated DMRS resources corresponding to a PRACH slot. The PUSCH resource indexes are sequentially numbered and are mapped to valid PUSCH occasions corresponding to a PRACH slot which are ordered, first, in increasing order of frequency resource indexes for frequency multiplexed PUSCH occasions; second, in increasing order of DMRS resource indexes within a PUSCH occasion, where a DMRS resource index DMRS_{id} is determined first in an ascending order of a DMRS port index and then in an ascending order of a DMRS sequence index, third in increasing order of time resource indexes for time multiplexed PUSCH occasions within a PUSCH slot and fourth, in increasing order of indexes for PUSCH slots. For the case of contention free 2-step random access type, if this field is absent, the UE shall use the value 0. For 2 step RA, rach-ConfigDedicated may include ra-ssb-OccasionMaskIndex which indicates a subset of RACH occasions per SSB which can be used amongst the RACH occasions for 2 step RA. The rach-ConfigDedicated may include PUSCH resource configuration(s) for msgA CFRA, msgA-TransMax (Max number of MsgA preamble transmissions performed before switching to 4-step type random access).

In operation 206, the CU may request the preparation of a candidate target cell controlled by the source DU by sending the UE Context Modification Request message to the source DU.

In operation 207, the source DU may provide the configuration of the UE in UE Context Modification Response message containing a container from DU to CU. The configuration may contain UE-specific parts and non-UE-specific parts.

Note that operations 206 and 207 may be not performed if candidate target cells of source DU are not identified in operation 203.

The configuration may include 4 step RA configuration (rach-ConfigCommon) and/or 2 step RA configuration (msgA-ConfigCommon). These RA configuration of candidate target cell are BWP specific and may be included in the respective BWP configuration of that candidate target cell. The configuration may be included in the UE Context Modification Response message.

Rach-ConfigCommon indicates prach-ConfigurationIndex which is used to identify the PRACH occasions in time domain. Rach-ConfigCommon indicates msg1-FDM (The number of PRACH transmission occasions FDMed in one time instance) and msg1-FrequencyStart (Offset of lowest PRACH transmission occasion in frequency domain with respective to PRB 0) to identify the PRACH occasions in frequency domain. Rach-ConfigCommon also indicates other parameters such as preambleReceivedTargetPower, preambleTransMax, powerRampingStep, ra-ResponseWindow, ra-ContentionResolutionTimer, rsrp-ThresholdSSB, rsrp-ThresholdSSBSUL, preamble group B configuration, msg1-SubcarrierSpacing and ssb-perRACH-OccasionAndCB-PreamblesPerSSB. Rach-ConfigCommon may include RA Prioritisation parameters (powerRampingStepHighPriority and scalingFactorBI) to be applied for 4 step RA initiated towards the cell upon LiL2 cell change/switch command.

The MsgA-ConfigCommon includes configuration of cell-specific MsgA PUSCH parameters such as MsgA PUSCH resources (msgA-PUSCH-ResourceGroupA) that the UE shall use when performing MsgA transmission using preambles group A, A PUSCH resources (msgA-PUSCH-ResourceGroupB) that the UE shall use when performing MsgA transmission using preambles group B. msgA-ConfigCommon indicates msgA-PRACH-ConfigurationIndex which is used to identify the PRACH occasions in time domain. MsgA-ConfigCommon indicates msgA-RO-FDM (The number of PRACH transmission occasions FDMed in one time instance) and msgA-RO-FrequencyStart (Offset of lowest PRACH transmission occasion in frequency domain with respective to PRB 0) to identify the PRACH occasions in frequency domain. MsgA-ConfigCommon also indicates other parameters such as msgA-PreambleReceivedTargetPower, preambleTransMax, msgA-TransMax, msgA-PreamblePowerRampingStep, msgB-ResponseWindow, ra-ContentionResolutionTimer, msgA-RSRP-ThresholdSSB, preamble group B configuration, msgA-SubcarrierSpacing and msgA-SSB-PerRACH-OccasionAndCB-PreamblesPerSSB. MsgA-ConfigCommon may include RA Prioritisation parameters (powerRampingStepHighPriority and scalingFactorBI) to be applied for 4 step RA initiated towards the cell upon L1L2 cell change/switch command.

The candidate target cell configuration of SpCell (that may be included in the UE Context Modification Response message) may include dedicated RA configuration (rach-ConfigDedicated for CFRA) for SUL and/or dedicated RA configuration (rach-ConfigDedicated) NUL to applied for RA initiated towards the cell upon LiL2 cell change/switch command indicating switching to the cell. The rach-ConfigDedicated may include RA Prioritisation parameters (powerRampingStepHighPriority and scalingFactorBI) to be applied for 4 step RA. The rach-ConfigDedicated may include RA Prioritisation parameters (powerRampingStepHighPriority and scalingFactorBI) to be applied for 2 step RA.

The rach-ConfigDedicated may include 4 step RA parameters such as prach-ConfigurationIndex, msg1-FDM, msg1-FrequencyStart to identify the PRACH occasions and other parameters such as preambleReceivedTargetPower, preambleTransMax, powerRampingStep, ra-ResponseWindow. For 4 step RA, rach-ConfigDedicated may include list of one or more {SSB index and RA preamble index to use in the RA occasions associated with this SSB} and/or list of one or more {CSI RS index, RA preamble index to use in the RA occasions associated with this CSI-RS and a list of RACH occasions for this CSI RS}. For 4 step RA, rach-ConfigDedicated may include ra-ssb-OccasionMaskIndex which indicates a subset of RACH occasions per SSB which can be used amongst the RACH occasions for 4 step RA.

The rach-ConfigDedicated may include 2 step RA parameters such as msgA-PRACH-ConfigurationIndex, msgA-RO-FDM, msgA-RO-FrequencyStart to identify the PRACH occasions and other parameters such as msgA-PreambleReceivedTargetPower, preambleTransMax, powerRampingStep, msgB-ResponseWindow. For 2 step RA, rach-ConfigDedicated may include MsgA PUSCH resources (msgA-CFRA-PUSCH) that the UE shall use when performing MsgA transmission for CFRA. For 2 step RA, rach-ConfigDedicated may include list of one or more {SSB index, RA preamble index to use in the RA occasions associated with this SSB, PUSCH resource index (msgA-PUSCH-Resource-Index) of PUSCH resource to be used for this SSB} and/or list of one or more {CSI RS index, RA preamble index and PUSCH resource index (msgA-PUSCH-Resource-Index) of PUSCH resource to be used for this SSB}. The PUSCH resource index indicates a valid PUSCH occasion and the associated DMRS resources corresponding to a PRACH slot. The PUSCH resource indexes are sequentially numbered and are mapped to valid PUSCH occasions corresponding to a PRACH slot which are ordered, first, in increasing order of frequency resource indexes for frequency multiplexed PUSCH occasions; second, in increasing order of DMRS resource indexes within a PUSCH occasion, where a DMRS resource index DMRS_{id} is determined first in an ascending order of a DMRS port index and then in an ascending order of a DMRS sequence index, third in increasing order of time resource indexes for time multiplexed PUSCH occasions within a PUSCH slot and fourth, in increasing order of indexes for PUSCH slots. For the case of contention free 2-step random access type, if this field is absent, the UE shall use the value 0. For 2 step RA, rach-ConfigDedicated may include ra-ssb-OccasionMaskIndex which indicates a subset of RACH occasions per SSB which may be used amongst the RACH occasions for 2 step RA. The rach-ConfigDedicated may include PUSCH resource configuration(s) for msgA CFRA, msgA-TransMax (Max number of MsgA preamble transmissions performed before switching to 4-step type random access).

Upon receiving the UE configurations for the candidate target cell(s), the CU may generate an RRC Reconfiguration in operation 208. The RRC Reconfiguration may include the configuration of candidate target cell(s) that is sent to the UE in operations 209/210. The RRC Reconfiguration may include separate RRC Reconfiguration IE for each of candidate target cell(s) or CellGroupConfig IE for each of candidate target cell(s).

In operation 209, CU may send the configuration to source DU. Then the source DU may send it to the UE through the RRC Reconfiguration in operation 210. Among other information, the RRC Reconfiguration message may contain: Measurement reporting configuration for L1/L2 mobility, i.e., configuration on how to report the Li beam measurements of serving and target cells; Configuration of the prepared candidate cell(s) which the UE needs to execute when it receives a L1/L2 command to change the serving cell, such as random access configuration as described earlier, radio bearer configurations, indication of whether to perform PDCP re-establishment or not (per DRB or common for all), indication of whether to perform PDCP level data recovery or not (per DRB or common for all), indication of whether to perform RLC re-establishment or not (per DRB or RLC channel or common for all), indication of whether to perform MAC reset or partial MAC reset or not, etc. RRC Reconfiguration may also include firstActiveUplinkBWP and firstActiveDownlinkBWP for each prepared candidate cell(s) and list of DL and UL BWP configurations for each prepared candidate cell(s). RRC Reconfiguration may also include InitialUplinkBWP and InitialDownlinkBWP for each prepared candidate cell(s) and list of DL and UL BWP configurations for each prepared candidate cell(s).

The UE may confirm the RRC Reconfiguration to the network in operations 211 and 212. In operation 211, the UE may transmit RRC reconfiguration complete message to the source DU. In operation 212, the source DU may transfer the RRC reconfiguration complete message to CU.

After confirming the RRC Reconfiguration to the network, the UE may start to report the L1 beam measurement of serving cell and candidate target cells in operation 213.

Based on measurements, serving cell (e.g., source DU of the serving cell) may decide to trigger cell change command in operation 214. In an example, upon determining that there is a target candidate cell having a better radio link/beam measurement than the serving cell, e.g., L1-RSRP of target beam measurement>L1-RSRP of serving beam measurement+Offset for a time period (i.e., Time-to-Trigger (TTT) period), the serving cell may send a L1 or L2 cell change/switch command in operation 215 to trigger the cell change to the target candidate cell. Target cell is indicated in Li or L2 cell change/switch command. It is to be noted that RRCReconfiguration may also be sent based on the measurements received in operation 213 and later when condition for cell change is met, serving cell may send a L1 or L2 cell change/switch command. L1 or L2 cell change/switch command can be sent using DCI or MAC CE.

Upon receiving the L1 or L2 cell change/switch command (MAC CE or DCI) for a target cell (e.g., SpCell), the UE may perform the following operations:
(Condition 1) In an embodiment, if timing advance (TA) was maintained by UE for the target cell (e.g., SpCell) before the L1/L2 cell switch change/command is received and time alignment timer (TAT) for timing advance group (TAG) of target cell is not running;
OR
(Condition 2) In an embodiment, if RRCReconfiguration message received in operation 210 or L1/L2 cell switch/change command received in operation 215 includes an indication to perform RA towards the target cell;
OR
(Condition 3): In an embodiment, if L1/L2 cell switch/change command received in operation 215 does not include TA of target cell and the UE does not have valid TA (e.g., TA received from network before the L1/L2 cell switch/change command or estimated by UE) of the target cell:

UE may initiate RA procedure towards the target cell. Indication to perform RA upon reception of L1/L2 cell switch/change command towards the target cell may be presence of ReconfigurationwithSync IE or a new indication in SpCellConfig received in operation 210.

Specifically, the UE may perform operations (e.g., UL carrier selection, BWP selection, RA type selection, msgA-TransMax handling, RA Prioritisation handling, SSB and Preamble selection, PRACH occasion selection, PUSCH occasion selection, etc.) described below for the RA procedure initiated upon reception of L1/L2 cell switch/change command.
UL carrier selection for RA procedure initiated upon reception of L1/L2 cell switch/change command
UL transmission such as RACH preamble, MsgA, Msg3, etc., during the RA procedure are transmitted to target cell on the selected UL carrier.
If SUL is not configured for the target cell, the UE selects NUL.
If SUL is configured for the target cell:
   In case that rach-ConfigDedicated is received/included in configuration of the target cell (received in operation 210),
      If rach-ConfigDedicated is received/included in configuration of the target cell for SUL, the UE selects SUL carrier. If rach-ConfigDedicated is received/included in configuration of the target cell for NUL, the UE selects NUL carrier. If rach-ConfigDedicated is received/included in configuration of the target cell for both SUL and NUL, the UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
   In case that rach-ConfigDedicated is not received/included in configuration of the target cell,
      The UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
(Alternative) If SUL is configured for target cell:
   In case that L1/L2 cell switch/change command (DCI or MAC CE) indicates the UL carrier to use:
      If SUL is indicated in L1/L2 cell switch/change command, the UE selects SUL carrier.
      If NUL is indicated in L1/L2 cell switch/change command, the UE selects NUL carrier.
   In case that L1/L2 cell switch/change command (DCI or MAC CE) does not indicate the UL carrier to use:
      (Option 1) The UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
      (Option 2) In case that rach-ConfigDedicated is received/included in configuration of the target cell,
         If rach-ConfigDedicated is received/included in configuration of the target cell for SUL, the UE selects SUL carrier. If rach-ConfigDedicated is received/included in configuration of the target cell for NUL, the UE selects NUL carrier. If rach-ConfigDedicated is received/included in configuration of the target cell for both SUL and NUL, the UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
      In case that rach-ConfigDedicated is not received/included in configuration of the target cell,
         The UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
U BWP selection for RA procedure initiated by L1/L2 cell switch/change command

### Option 1:

The UE uses the BWPs corresponding to BWP IDs indicated by fields firstActiveUplinkBWP and firstActiveDownlinkBWP included in configuration of target cell received in operation 210. The BWP configuration of BWPs indicated by fields firstActiveUplinkBWP and firstActiveDownlinkBWP is also provided in configuration of target cell received in operation 210.

If firstActiveUplinkBWP is not configured/included in configuration of target cell received in operation 210, the UE uses the initialUplinkBWP configured/included in configuration of target cell received in operation 210.

If firstActiveDownlinklinkBWP is not configured/included in configuration of target cell received in operation 210, the UE uses the initialDownlinkBWP configured/included in configuration of target cell received in operation 210.

If RACH is to be performed on the target cell and firstActiveUplinkBWP is not configured with RACH occasions, the UE uses the UL BWP indicated by initialUplinkBWP for UL and DL BWP indicated by initialDownlinkBWP (if firstActiveDownlinkBWP is not the same as initialDownlinkBWP) wherein fields initialUplinkBWP and initialDownlinkBWP are included in configuration of target cell received in operation 210.

### Option 2:

DL/UL BWPs (BWP IDs) to be used are indicated in L1/L2 cell change/switch command. UE uses the indicated BWPs in the target cell. The BWP configuration of BWPs indicated by L1/L2 cell change/switch command is provided in configuration of target cell received in operation 210.

### Option 3:

The DL/UL BWPs (BWP IDs) to be used are optionally indicated in L1/L2 cell change/switch command. The BWP configuration of BWPs indicated by L1/L2 cell change/switch command is provided in configuration of target cell received in operation 210.
If Uplink BWP ID is not present in L1/L2 cell change/switch command:
   The UE uses the BWP indicated by field firstActiveUplinkBWP in configuration of target cell received in operation 210;
   If firstActiveUplinkBWP is not configured/included in configuration of target cell received in operation 210, the UE uses the initialUplinkBWP configured/included in configuration of target cell received in operation 210.
Else,
   The UE uses the UL BWP indicated in L1/L2 cell change/switch command.
If Downlink BWP ID is not present in L1/L2 cell change/switch command:
   The UE uses the BWP indicated by field firstActiveDownlinkBWP in configuration of target cell received in operation 210;
   If firstActiveDownlinkBWP is not configured/included in configuration of target cell received in operation 210, the UE uses the initialDownlinkBWP configured/included in configuration of target cell received in operation 210.
Else,
   The UE uses the UL BWP indicated in L1/L2 cell change/switch command.
RA Type selection for RA procedure initiated by L1/L2 cell switch/change command

### Option 1:

If the contention-free random access resources for 4-step RA type have been explicitly provided in rach-ConfigDedicated (rach-ConfigDedicated is received/included in configuration of the target cell in operation 210) for the BWP selected for random access procedure: the UE performs/initiates 4-step RA procedure.

Else if the contention-free random access resources for 2-step RA type have been explicitly provided in rach-ConfigDedicated for the BWP selected for random access procedure: UE performs/initiates 2-step RA procedure.

Else if the BWP selected for random access procedure is configured with both 2-step and 4-step RA type random access resources and the RSRP of the downlink pathloss reference is above msgA-RSRP-Threshold: UE performs/initiates 2-step RA procedure.
Else,
The UE performs/initiates 4-step RA procedure.

### Option 2:

If the contention-free random access resources for only 4-step RA type have been explicitly provided in rach-ConfigDedicated (rach-ConfigDedicated is received/included in configuration of the target cell in operation 210) for the BWP selected for random access procedure: the UE performs/initiates 4-step RA procedure.

Else if the contention-free random access resources for only 2-step RA type have been explicitly provided in rach-ConfigDedicated (rach-ConfigDedicated is received/included in configuration of the target cell in operation 210) for the BWP selected for random access procedure: the UE performs/initiates 2-step RA procedure.

Else if the BWP selected for random access procedure is configured with both 2-step and 4-step RA type random access resources and the RSRP of the downlink pathloss reference is above msgA-RSRP-Threshold: UE performs/initiates 2-step RA procedure.

Else,

The UE performs/initiates 4-step RA procedure.
U msgA-TransMax handling:
If 2 step RA is selected above,
1> if the random access procedure was initiated for reconfiguration with sync or for SCG activation or for cell change triggered by L1L2 cell change/switch command (MAC CE or DCI); and
1> if cfra-TwoStep is configured for the selected carrier (note cfra-TwoStep IE is optionally included in rach-ConfigDedicated):
   2> if msgA-TransMax is configured in the cfra-TwoStep:
      3> apply msgA-TransMax configured in the cfra-TwoStep.
1> else if msgA-TransMax is included in the RACH-ConfigCommonTwoStepRA (msgA-ConfigCommon includes RACH-ConfigCommonTwoStepRA):
   2> apply msgA-TransMax included in the RACH-ConfigCommonTwoStepRA.
RA Prioritisation handling for 2 step RA:
If 2 step RA is selected above,
1> if the random access procedure was initiated for reconfiguration with sync or for SCG activation or for cell change triggered by LiL2 cell change/switch command (MAC CE or DCI); and
1> if rach-ConfigDedicated is configured for the selected carrier; and
1> if ra-PrioritizationTwoStep is configured in the rach-ConfigDedicated:
2> set PREAMBLE_POWER_RAMPING_STEP to the powerRampingStepHighPriority included in the ra-PrioritizationTwoStep in rach-ConfigDedicated;
2> if scalingFactorBI is configured in ra-PrioritizationTwoStep in the rach-ConfigDedicated:
   3> set SCALING_FACTOR_BI to the scalingFactorBI.
RA Prioritisation handling for 4 step RA:
If 4 step RA is selected above,
1> if the random access procedure was initiated for reconfiguration with sync or for SCG activation; and
1> if rach-ConfigDedicated is configured for the selected carrier; and
1> if ra-Prioritization is configured in the rach-ConfigDedicated:
   2> set PREAMBLE_POWER_RAMPING_STEP to the powerRampingStepHighPriority included in the ra-Prioritization in rach-ConfigDedicated;
   2> if scalingFactorBI is configured in ra-Prioritization in the rach-ConfigDedicated:
      3> set SCALING_FACTOR_BI to the scalingFactorBI.

If the selected RA_TYPE is set to 4-step RA, the MAC entity shall:
SSB and Preamble selection
1> if the contention-free Random Access Resources associated with SSBs have been explicitly provided in rach-ConfigDedicated in operation 210 and at least one SSB with SS-RSRP above rsrp-ThresholdSSB amongst the associated SSBs is available:
   2> select an SSB with SS-RSRP above rsrp-ThresholdSSB amongst the associated SSBs;
   2> set the PREAMBLE_INDEX to a ra-PreambleIndex corresponding to the selected SSB.
1> else if the contention-free Random Access Resources associated with CSI-RSs have been explicitly provided in rach-ConfigDedicated in operation 210 and at least one CSI-RS with CSI-RSRP above rsrp-ThresholdCSI-RS amongst the associated CSI-RSs is available:
   2> select a CSI-RS with CSI-RSRP above rsrp-ThresholdCSI-RS amongst the associated CSI-RSs;
   2> set the PREAMBLE_INDEX to a ra-PreambleIndex corresponding to the selected CSI-RS.
1> else (i.e., for the contention-based Random Access preamble selection): perform operation as in legacy

PRACH occasion selection
1> if an SSB is selected above:
   2> determine the next available PRACH occasion from the PRACH occasions corresponding to the selected SSB permitted by the restrictions given by the ra-ssb-OccasionMaskIndex if configured, or ssb-SharedRO-MaskIndex if configured
1> else if a CSI-RS is selected above:
   2> determine the next available PRACH occasion from the PRACH occasions in ra-OccasionList corresponding to the selected CSI-RS

Note: PRACH occasions are determined using the prach-ConfigurationIndex included in rach-ConfigDedicated in operation 210. If prach-ConfigurationIndex is not included in rach-ConfigDedicated, PRACH occasions are determined using the prach-ConfigurationIndex in RACH-ConfigCommon (in operation 210) of BWP selected for RA procedure. The rach-ConfigDedicated is the one corresponding to selected UL carrier.
1> perform the random access preamble transmission procedure.

If the selected RA_TYPE is set to 2-stepRA, the MAC entity shall:

U SSB and Preamble selection
1> if the contention-free 2-step RA type Resources associated with SSBs have been explicitly provided in rach-ConfigDedicated in operation 210 and at least one SSB with SS-RSRP above msgA-RSRP-ThresholdSSB amongst the associated SSBs is available:
   2> select an SSB with SS-RSRP above msgA-RSRP-ThresholdSSB amongst the associated SSBs;
   2> set the PREAMBLE_INDEX to a ra-PreambleIndex corresponding to the selected SSB.
   1> else (i.e., for the contention-based Random Access Preamble selection): perform operation as in legacy

PRACH Occasion Selection
1> determine the next available PRACH occasion from the PRACH occasions corresponding to the selected SSB permitted by the restrictions given by the msgA-SSB-SharedRO-MaskIndex if configured, or ra-ssb-OccasionMaskIndex if configured, or ssb-SharedRO-MaskIndex if configured.

PUSCH Occasion Selection
1> if the random access preamble was not selected by the MAC entity among the contention-based random access preamble(s):
   2> select a PUSCH occasion from the PUSCH occasions configured in msgA-CFRA-PUSCH (in operation 210) corresponding to the PRACH slot of the selected PRACH occasion, according to msgA-PUSCH-Resource-Index corresponding to the selected SSB;
   2> determine the UL grant and the associated HARQ information for the MSGA payload in the selected PUSCH occasion;
   2> deliver the UL grant and the associated HARQ information to the HARQ entity.
1> else:
   2> select a PUSCH occasion corresponding to the selected preamble and PRACH occasion;
   2> determine the UL grant for the MSGA payload according to the PUSCH configuration associated with the selected random access preambles group and determine the associated HARQ information;
   2> if the selected preamble and PRACH occasion is mapped to a valid PUSCH occasion:
      3> deliver the UL grant and the associated HARQ information to the HARQ entity.
1> perform the MSGA transmission procedure.

In an embodiment, L1/L2 triggered mobility/cell change may be completed by sending L2 Message like C-RNTI MAC CE or by sending L3 message like RRC Reconfiguration Complete in response to the received. L1/L2 cell change command.

### Method 2

Operations 201 to 215 of FIG. 2 may be applied to method 2. Therefore, the description of FIG. 2 described above may be referred to, and redundant description will be omitted for convenience.

In an alternative embodiment of the procedure described above,
LiL2 cell change/switch command (MAC CE or DCI) may include CFRA configuration/resources for 4 step RA comprising of at least a list of one or more {SSB index and RA preamble index to use in the RA occasions associated with this SSB} and/or a list of one or more {CSI RS index, RA preamble index to use in the RA occasions associated with this CSI-RS and a list of RACH occasions for this CSI RS}. The size of the list may be one. The UE may select the SSB and RA preamble index indicated in L1L2 cell change/switch command during the RA procedure. ra-ssb-OccasionMaskIndex and/or ssb-SharedRO-MaskIndex and/or ra-OccasionList may also be included in LiL2 cell change/switch command. If not included in LiL2 cell change/switch command, the UE may apply ra-ssb-OccasionMaskIndex and/or ssb-SharedRO-MaskIndex and/or ra-OccasionList configured in rach-ConfigDedicated in operation 210.
   In an alternative embodiment, rach-ConfigDedicated in operation 210 may include a list X of one or more {SSB index and RA preamble index to use in the RA occasions associated with this SSB} and/or a list Y of one or more {CSI RS index, RA preamble index to use in the RA occasions associated with this CSI-RS and a list of RACH occasions for this CSI RS}. One or more row indexes of list X and/or list Y or row index of combined the list X and the list Y may be signaled in L1/L2 cell switch change/command. Based on row index(es), the UE may identify list of one or more {SSB index and RA preamble index to use in the RA occasions associated with this SSB} and/or list of one or more {CSI RS index, RA preamble index to use in the RA occasions associated with this CSI-RS and a list of RACH occasions for this CSI RS} signaled in LiL2 cell change/switch command.
LiL2 cell change/switch command (MAC CE or DCI) may include CFRA configuration/resources for 2 step RA comprising of at least, a list of one or more {SSB index, RA preamble index to use in the RA occasions associated with this SSB, PUSCH resource index (msgA-PUSCH-Resource-Index) of PUSCH resource to be used for this SSB} and/or a list of one or more {CSI RS index, RA preamble index and PUSCH resource index (msgA-PUSCH-Resource-Index) of PUSCH resource to be used for this SSB}. The size of the list can be one.
   In an alternative embodiment, the rach-ConfigDedicated in operation 210 may include a list X of one or more {SSB index and RA preamble index to use in the RA occasions associated with this SSB, PUSCH resource index (msgA-PUSCH-Resource-Index) of PUSCH resource to be used for this SSB} and/or a list Y of one or more {CSI RS index, RA preamble index to use in the RA occasions associated with this CSI-RS and a list of RACH occasions for this CSI RS, PUSCH resource index (msgA-PUSCH-Resource-Index) of PUSCH resource to be used for this CSI-RS}. One or more row indexes of the list X and/or the list Y or row index of combined the list X and the list Y may be signaled in L1/L2 cell switch change/command. Based on row index(es), the UE may identify a list of one or more {SSB index and RA preamble index to use in the RA occasions associated with this SSB, PUSCH resource index (msgA-PUSCH-Resource-Index) of PUSCH resource to be used for this SSB} and/or a list of one or more {CSI RS index, RA preamble index to use in the RA occasions associated with this CSI-RS and a list of RACH occasions for this CSI RS, PUSCH resource index (msgA-PUSCH-Resource-Index) of PUSCH resource to be used for this CSI-RS} signaled in L1L2 cell change/switch command.
Upon receiving the L1 or L2 cell change/switch command (MAC CE or DCI) for a target cell (e.g., SpCell), the UE may perform the following operations:
(Condition 1) In an embodiment, if the TA was maintained by the UE for the target cell (e.g., SpCell) before the L1/L2 cell switch change/command is received and TAT for TAG of target cell is not running;
OR
(Condition 2) In an embodiment, if the RRCReconfiguration message received in operation 210 or L1/L2 cell switch/change command received in operation 215 includes an indication to perform the RA towards the target cell;
OR
(Condition 3): In an embodiment, if L1/L2 cell switch/change command received in operation 215 does not include the TA of target cell and the UE does not have a valid TA (e.g., TA received from network before the L1/L2 cell switch/change command or estimated by the UE) of the target cell:

The UE may initiate RA procedure towards the target cell. In an embodiment, indication to perform RA upon reception of L1/L2 cell switch/change command towards the target cell may be presence of ReconfigurationwithSync IE or a new indication in SpCellConfig received in operation 210.

Specifically, the UE may perform operations (e.g., UL carrier selection, BWP selection, RA type selection, msgA-TransMax handling, RA Prioritisation handling, SSB and Preamble selection, PRACH occasion selection, PUSCH occasion selection, etc.) described below for the RA procedure initiated by L1/L2 cell switch/change command.

UL carrier selection for RA procedure initiated by L1/L2 cell switch/change command.

UL transmission such as RACH preamble, MsgA, Msg3, etc., during the RA procedure are transmitted to target cell on the selected UL carrier.
If SUL is not configured for target cell, the UE selects NUL.
If SUL is configured for target cell:
In case that rach-ConfigDedicated is received/included in configuration of the target cell (received in operation 210),
   If rach-ConfigDedicated is received/included in configuration of the target cell (received in operation 210) for SUL, the UE selects SUL carrier. If rach-ConfigDedicated is received/included in configuration of the target cell (received in operation 210) for NUL, the UE selects NUL carrier. If rach-ConfigDedicated is received/included in configuration of the target cell (received in operation 210) for both SUL and NUL, the UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
In case that rach-ConfigDedicated is not received/included in configuration of the target cell (received in operation 210),
   The UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
(Alternative) If SUL is configured for target cell:
   In case that L1/L2 cell switch/change command (DCI or MAC CE) indicates the UL carrier to use:
      If SUL is indicated in L1/L2 cell switch/change command, the UE selects SUL carrier.
      If NUL is indicated in L1/L2 cell switch/change command, the UE selects NUL carrier.
   In case that L1/L2 cell switch/change command (DCI or MAC CE) does not indicate the UL carrier to use:
      (Option 1) The UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
      (Option 2) In case that rach-ConfigDedicated is received/included in configuration of the target cell (received in operation 210),
         If the rach-ConfigDedicated is received/included in configuration of the target cell (received in operation 210) for SUL, the UE selects SUL carrier. If rach-ConfigDedicated is received/included in configuration of the target cell (received in operation 210) for NUL, the UE selects NUL carrier. If rach-ConfigDedicated is received/included in configuration of the target cell (received in operation 210) for both SUL and NUL, the UE select UL carrier based on RSRP threshold rsrp-ThresholdSSB-SUL. If the RSRP of the downlink pathloss reference is less than rsrp-ThresholdSSB-SUL the UE selects SUL, otherwise NUL.
      In case that rach-ConfigDedicated is not received/included in configuration of the target cell (received in operation 210),
         The UE selects UL carrier based on RSRP threshold rsrp-ThresholdSSB-SUL. If the RSRP of the downlink pathloss reference is less than rsrp-ThresholdSSB-SUL the UE selects SUL, otherwise NUL.
BWP selection for RA procedure initiated by L1/L2 cell switch/change command

### Option 1:

The UE uses the BWPs corresponding to BWP IDs indicated by fields firstActiveUplinkBWP and firstActiveDownlinkBWP included in configuration of target cell received in operation 210. The BWP configuration of BWPs indicated by fields firstActiveUplinkBWP and firstActiveDownlinkBWP is also provided in configuration of target cell received in operation 210.

If firstActiveUplinkBWP is not configured/included in configuration of target cell received in operation 210, the UE uses the initialUplinkBWP configured/included in configuration of target cell received in operation 210.

If firstActiveDownlinkBWP is not configured/included in configuration of target cell received in operation 210, the UE uses the initialDownlinkBWP configured/included in configuration of target cell received in operation 210.

If the RACH is to be performed on the target cell and firstActiveUplinkBWP is not configured with RACH occasions, the UE uses the UL BWP indicated by initialUplinkBWP for UL and DL BWP indicated by initialDownlinkBWP (if firstActiveDownlinkBWP is not the same as initialDownlinkBWP) wherein fields initialUplinkBWP and initialDownlinkBWP are included in configuration of target cell received in operation 210.

### Option 2:

DL/UL BWPs (BWP IDs) to be used are indicated in L1/L2 cell change/switch command. The UE uses the indicated BWPs in the target cell. The BWP configuration of BWPs indicated by L1/L2 cell change/switch command is provided in configuration of target cell received in operation 210.

### Option 3:

DL/UL BWPs (BWP IDs) to be used are optionally indicated in L1/L2 cell change/switch command. The BWP configuration of BWPs indicated by L1/L2 cell change/switch command is provided in configuration of target cell received in operation 210.
If Uplink BWP ID is not present in L1/L2 cell change/switch command:
   The UE uses the BWP indicated by field firstActiveUplinkBWP in configuration of target cell received in operation 210;
   If firstActiveUplinkBWP is not configured/included in configuration of target cell received in operation 210, the UE uses the initialUplinkBWP configured/included in configuration of target cell received in operation 210.
Else,
   The UE uses the UL BWP indicated in L1/L2 cell change/switch command.
If Downlink BWP ID is not present in L1/L2 cell change/switch command:
   The UE uses the BWP indicated by field firstActiveDownlinkBWP in configuration of target cell received in operation 210;
   If firstActiveDownlinkBWP is not configured/included in configuration of target cell received in operation 210, the UE uses the initialDownlinkBWP configured/included in configuration of target cell received in operation 210.
Else,
   The UE uses the UL BWP indicated in L1/L2 cell change/switch command.
RA Type selection for RA procedure initiated by L1/L2 cell switch/change command

### Option 1:

If the contention-free random access resources for 4-step RA type have been explicitly provided in rach-ConfigDedicated for the BWP selected for random access procedure or in L1/L2 cell switch/change command: the UE performs/initiates 4-step RA procedure.

Else if the contention-free random access resources for 2-step RA type have been explicitly provided in rach-ConfigDedicated for the BWP selected for random access procedure or in L1/L2 cell switch/change command: the UE performs/initiates 2-step RA procedure.

Else if the BWP selected for random access procedure or L1/L2 cell switch/change command is configured with/includes both 2-step and 4-step RA type random access resources and the RSRP of the downlink pathloss reference is above msgA-RSRP-Threshold: the UE performs/initiates 2-step RA procedure.

Else,

The UE performs/initiates 4-step RA procedure.

### Option 2:

If the contention-free random access resources for only 4-step RA type have been explicitly provided in rach-ConfigDedicated for the BWP selected for random access procedure or in L1/L2 cell switch/change command: UE performs/initiates 4-step RA procedure.

Else if the contention-free random access resources for only 2-step RA type have been explicitly provided in rach-ConfigDedicated for the BWP selected for random access procedure or in L1/L2 cell switch/change command: UE performs/initiates 2-step RA procedure.

Else if the BWP selected for random access procedure or L1/L2 cell switch/change command is configured with/includes with both 2-step and 4-step RA type random access resources and the RSRP of the downlink pathloss reference is above msgA-RSRP-Threshold: UE performs/initiates 2-step RA procedure.

Else,

UE performs/initiates 4-step RA procedure.
U msgA-TransMax handling

If 2 step RA is selected above,
1> if the random access procedure was initiated for reconfiguration with sync or for SCG activation or for cell change triggered by L1L2 cell change/switch command (MAC CE or DCI); and
1> if cfra-TwoStep is configured for the selected carrier (note cfra-TwoStep IE is optionally included in rach-ConfigDedicated):
   2> if msgA-TransMax is configured in the cfra-TwoStep:
      3> apply msgA-TransMax configured in the cfra-TwoStep.
1> else if msgA-TransMax is included in the RACH-ConfigCommonTwoStepRA (msgA-ConfigCommon includes RACH-ConfigCommonTwoStepRA):
   2>apply msgA-TransMax included in the RACH-ConfigCommonTwoStepRA.
RA Prioritisation handling

If 2 step RA is selected above,
1> If the random access procedure was initiated for reconfiguration with sync or for SCG activation or for cell change triggered by LiL2 cell change/switch command (MAC CE or DCI); and
1> if rach-ConfigDedicated is configured for the selected carrier; and
1> if ra-PrioritizationTwoStep is configured in the rach-ConfigDedicated:
   2> set PREAMBLE_POWER_RAMPING_STEP to the powerRampingStepHighPriority included in the ra-PrioritizationTwoStep in rach-ConfigDedicated;
   2> if scalingFactorBI is configured in ra-PrioritizationTwoStep in the rach-ConfigDedicated:
      3> set SCALING_FACTOR_BI to the scalingFactorBI.

If 4 step RA is selected above,
1> If the random access procedure was initiated for reconfiguration with sync or for SCG activation; and
1> if rach-ConfigDedicated is configured for the selected carrier; and
1> if ra-Prioritization is configured in the rach-ConfigDedicated:
   2> set PREAMBLE_POWER_RAMPING_STEP to the powerRampingStepHighPriority included in the ra-Prioritization in rach-ConfigDedicated;
   2> if scalingFactorBI is configured in ra-Prioritization in the rach-ConfigDedicated:
      3> set SCALING_FACTOR_BI to the scalingFactorBI.

If the selected RA_TYPE is set to 4-stepRA, the MAC entity shall:

U SSB & Preamble Selection
1> If the contention-free random access resources associated with SSBs have been explicitly provided in L1L2 cell change/switch command (MAC CE or DCI) in operation 215 and at least one SSB with SS-RSRP above rsrp-ThresholdSSB amongst the associated SSBs is available:
   2> select an SSB with SS-RSRP above rsrp-ThresholdSSB amongst the associated SSBs (i.e., SSBs in in L1L2 cell change/switch command); In an embodiment, in case there is only one SSB in L1L2 cell change/switch command, the UE may select that SSB.
   2> set the PREAMBLE_INDEX to a ra-PreambleIndex corresponding to the selected SSB. In an embodiment, in case there is only one ra-PreambleIndex in LiL2 cell change/switch command, the UE may select that ra-PreambleIndex.
1> else if the contention-free random access resources associated with CSI-RSs have been explicitly provided in L1L2 cell change/switch command (MAC CE or DCI) in operation 215 and at least one CSI-RS with CSI-RSRP above rsrp-ThresholdCSI-RS amongst the associated CSI-RSs is available:
   2> select a CSI-RS with CSI-RSRP above rsrp-ThresholdCSI-RS amongst the associated CSI-RSs (i.e., CSI-RSs in L1L2 cell change/switch command);
   2> set the PREAMBLE_INDEX to a ra-PreambleIndex corresponding to the selected CSI-RS.
1> else if the contention-free random access resources associated with SSBs have been explicitly provided in rach-ConfigDedicated in operation 210 and at least one SSB with SS-RSRP above rsrp-ThresholdSSB amongst the associated SSBs is available:
   2> select an SSB with SS-RSRP above rsrp-ThresholdSSB amongst the associated SSBs (i.e., SSBs in in rach-ConfigDedicated);
   2> set the PREAMBLE_INDEX to a ra-PreambleIndex corresponding to the selected SSB.
1> else if the contention-free random access resources associated with CSI-RSs have been explicitly provided in rach-ConfigDedicated in operation 210 and at least one CSI-RS with CSI-RSRP above rsrp-ThresholdCSI-RS amongst the associated CSI-RSs is available:
   2> select a CSI-RS with CSI-RSRP above rsrp-ThresholdCSI-RS amongst the associated CSI-RSs (i.e., CSI-RSs in rach-ConfigDedicated);
   2> set the PREAMBLE_INDEX to a ra-PreambleIndex corresponding to the selected CSI-RS.
1> else (i.e., for the contention-based random access preamble selection): perform operation as in legacy.

Alternative (here it is assumed that rach-ConfigDedicated does not provide contention-free Random Access Resources associated with SSBs or CSI-RSs for 4 step RA):
1> if the contention-free random access resources associated with SSBs have been explicitly provided in L1L2 cell change/switch command (MAC CE or DCI) in operation 215 (and at least one SSB with SS-RSRP above rsrp-ThresholdSSB amongst the associated SSBs is available):
   2> select an SSB with SS-RSRP above rsrp-ThresholdSSB amongst the associated SSBs (i.e., SSBs in in L1L2 cell change/switch command); In an embodiment, in case there is only one SSB indicated in LiL2 cell change/switch command, the UE may select that SSB.
   2> set the PREAMBLE_INDEX to a ra-PreambleIndex corresponding to the selected SSB. In an embodiment, in case there is only one ra-PreambleIndex in LiL2 cell change/switch command, the UE may select that ra-PreambleIndex.
1> else if the contention-free random access resources associated with CSI-RSs have been explicitly provided in L1L2 cell change/switch command (MAC CE or DCI) in operation 215 (and at least one CSI-RS with CSI-RSRP above rsrp-ThresholdCSI-RS amongst the associated CSI-RSs is available):
   2> select a CSI-RS with CSI-RSRP above rsrp-ThresholdCSI-RS amongst the associated CSI-RSs (i.e., CSI-RSs in L1L2 cell change/switch command);
   2> set the PREAMBLE_INDEX to a ra-PreambleIndex corresponding to the selected CSI-RS.
1> else (i.e., for the contention-based random access preamble selection): perform operation as in legacy.

PRACH Occasion Selection
1> if an SSB is selected above:
   2> determine the next available PRACH occasion from the PRACH occasions corresponding to the selected SSB permitted by the restrictions given by the ra-ssb-OccasionMaskIndex if configured, or ssb-SharedRO-MaskIndex if configured
1> else if a CSI-RS is selected above:
   2> determine the next available PRACH occasion from the PRACH occasions in ra-OccasionList corresponding to the selected CSI-RS.

Note: PRACH occasions are determined using the prach-ConfigurationIndex included in rach-ConfigDedicated in operation 210. If prach-ConfigurationIndex is not included in rach-ConfigDedicated, PRACH occasions are determined using the prach-ConfigurationIndex in RACH-ConfigCommon in operation 210 of BWP selected for RA procedure. The rach-ConfigDedicated is the one corresponding to selected UL carrier.

1> perform the Random Access Preamble transmission procedure.

If the selected RA_TYPE is set to 2-stepRA, the MAC entity shall:

U SSB & Preamble Selection
1> if the contention-free 2-step RA type Resources associated with SSBs have been explicitly provided in L1L2 cell change/switch command (MAC CE or DCI) in operation 215 (and at least one SSB with SS-RSRP above msgA-RSRP-ThresholdSSB amongst the associated SSBs is available):
   2> select an SSB with SS-RSRP above msgA-RSRP-ThresholdSSB amongst the associated SSBs (i.e., SSBs in L1L2 cell change/switch command); In an embodiment, in case there is only one SSB in L1L2 cell change/switch command, the UE may select that SSB.
   2> set the PREAMBLE_INDEX to a ra-PreambleIndex corresponding to the selected SSB. In an embodiment, in case there is only one ra-PreambleIndex in LiL2 cell change/switch command, the UE may select that ra-PreambleIndex.
   2> msgA-PUSCH-Resource-Index in L1L2 cell change/switch command corresponding to selected SSB is used for selecting PUSCH occasion. In an embodiment, in case there is only one msgA-PUSCH-Resource-Index in L1L2 cell change/switch command, the UE may select that msgA-PUSCH-Resource-Index.
1> else if the contention-free 2-step RA type resources associated with SSBs have been explicitly provided in rach-ConfigDedicated in operation 210 (and at least one SSB with SS-RSRP above msgA-RSRP-ThresholdSSB amongst the associated SSBs is available):
   2> select an SSB with SS-RSRP above msgA-RSRP-ThresholdSSB amongst the associated SSBs (i.e., SSBs in in rach-ConfigDedicated);
   2> set the PREAMBLE_INDEX to a ra-PreambleIndex corresponding to the selected SSB.
   2> msgA-PUSCH-Resource-Index in rach-ConfigDedicated corresponding to selected SSB is used for selecting PUSCH occasion
1> else (i.e., for the contention-based Random Access Preamble selection): perform operation as in legacy.

Alternative (here it is assumed that rach-ConfigDedicated does not provide contention-free Random Access Resources associated with SSBs or CSI-RSs for 2 step RA):
1> if the contention-free 2-step RA type resources associated with SSBs have been explicitly provided in L1L2 cell change/switch command (MAC CE or DCI) in operation 215 and at least one SSB with SS-RSRP above msgA-RSRP-ThresholdSSB amongst the associated SSBs is available:
   2> select an SSB with SS-RSRP above msgA-RSRP-ThresholdSSB amongst the associated SSBs (i.e., SSBs in L1L2 cell change/switch command);
   2> set the PREAMBLE_INDEX to a ra-PreambleIndex corresponding to the selected SSB.
   2> msgA-PUSCH-Resource-Index in L1L2 cell change/switch command corresponding to selected SSB is used for selecting PUSCH occasion
1> else (i.e., for the contention-based Random Access Preamble selection): perform operation as in legacy.
U PRACH occasion selection
1> determine the next available PRACH occasion from the PRACH occasions corresponding to the selected SSB permitted by the restrictions given by the msgA-SSB-SharedRO-MaskIndex if configured, or ra-ssb-OccasionMaskIndex if configured, or ssb-SharedRO-MaskIndex if configured.

Note: PRACH occasions are determined using the msgA-PRACH-ConfigurationIndex included in rach-ConfigDedicated in operation 210. If msgA-PRACH-ConfigurationIndex is not included in rach-ConfigDedicated, PRACH occasions are determined using the msgA-PRACH-ConfigurationIndex in RACH-ConfigCommonTwoStepRA in operation 210 of BWP selected for RA procedure. The rach-ConfigDedicated is the one corresponding to selected UL carrier.

PUSCH Occasion Selection
1> if the random access preamble was not selected by the MAC entity among the contention-based random access preamble(s):
   2> select a PUSCH occasion from the PUSCH occasions configured in msgA-CFRA-PUSCH in operation 210 corresponding to the PRACH slot of the selected PRACH occasion, according to msgA-PUSCH-Resource-Index corresponding to the selected SSB;
   2> determine the UL grant and the associated HARQ information for the MSGA payload in the selected PUSCH occasion;
   2> deliver the UL grant and the associated HARQ information to the HARQ entity.
1> else:
   2> select a PUSCH occasion corresponding to the selected preamble and PRACH occasion;
   2> determine the UL grant for the MSGA payload according to the PUSCH configuration associated with the selected random access preambles group and determine the associated HARQ information;
   2> if the selected preamble and PRACH occasion is mapped to a valid PUSCH occasion:
      3> deliver the UL grant and the associated HARQ information to the HARQ entity.
1> perform the MSGA transmission procedure.

MAC reset for Intra-DU SpCell change

In case of legacy handover, MAC is reset when handover command is executed. In case of intra-DU PCell change triggered by LTM, some of the operations performed by MAC entity during the MAC reset are not needed. The UE may perform the following operations upon receiving the cell change/switch command, if partial MAC reset indication (via MAC CE or DCI or RRC) is received.

1. TIMEALIGNMENTIIMER

If target SpCell is one of the current serving cell of the cell group (CG):
There is no need to stop the running timeAlignmentTimer associated with TAG of that cell by the MAC entity.
If target SpCell and current SpCell belong to different TAG, timeAlignmentTimer associated with TAG of current SpCell is stopped by MAC entity as current SpCell is not available upon cell change.

If target SpCell is not one of the current serving cell of the CG:
If random access is initiated towards the target SpCell, timeAlignmentTimer associated with PTAG is stopped by MAC entity. It may be not needed to stop timeAlignmentTimer associated with STAG in this case. But stopping timeAlignmentTimer associated with STAG may be considered.

2. RACH

RA configuration is cell specific. So the ongoing RACH procedure in the MAC entity may be stopped and MsgA/Msg3 buffer may be flushed. At the time SpCell change is triggered, CFRA resources may be configured for SpCell BFR. These may be discarded.

3. Scheduling Request (SR) Procedure

SR procedure triggered for current SpCell (e.g., triggered by LBT failure or for BFR or due to PUCCH resources not being configured, etc.) in the MAC entity may be stopped. There is no benefit of continuing ongoing SR procedure upon SpCell change.

4. BUFFER STATUS REPORTING PROCEDURE

Triggered buffer status reporting procedure in the MAC entity (at least regular BSR) may be continued to reduce delay in reporting BSR upon SpCell change.

5. CONSISTENT LBT FAILURE

Triggered consistent LBT failure may be cancelled as LBT failure is specific to physical resources of cell. LBT_COUNTER of SpCell may be also reset.

6. BEAM FAILURE RECOVERY (BFR)

Triggered BFR may be cancelled as BFR is specific cell and BFI_COUNTER may be reset.

7. UL HARQ

HARQ retransmissions of an ongoing HARQ process on the new SpCell can be considered to avoid packet loss and RLC retransmission. To enable this, there is no need to set new data indicators (NDIs) for all uplink HARQ processes of the SpCell to the value 0.

8. DL HARQ

HARQ retransmissions of an ongoing HARQ process on the new SpCell can be considered to avoid packet loss and RLC retransmission. To enable this, Soft buffers for all DL HARQ processes of SpCell are not flushed.

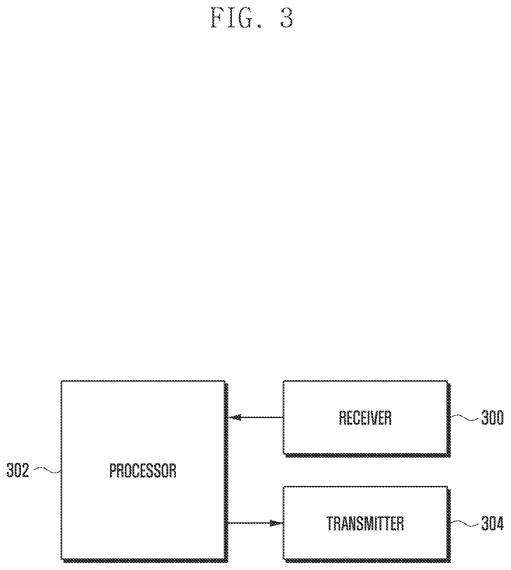

FIG. 3 illustrates a block diagram of a UE according to an embodiment of the disclosure.

Referring to FIG. 3, the UE includes a receiver 300, a transmitter 304, and a processor 302. The receiver 300 and the transmitter 304 may be commonly referred to as a transceiver. The transceiver may transmit and receive a signal to and from a BS. The signal may include control information and data. To this end, the transceiver may include a radio frequency (RF) transmitter that up-converts and amplifies the frequency of a transmitted signal, an RF receiver that low-noise amplifies a received signal and down-converts the frequency, etc. Further, the transceiver may receive a signal through a wireless channel, output the signal to the processor 302, and transmit the signal output from the processor 302 through a wireless channel.

The processor 302 may control a series of processes so that the UE operates according to embodiments of the disclosure. For example, the processor 302 controls operations for the UE according to the above-described embodiment of the disclosure. The processor 302 is configured to receive, from a base station of a serving cell, a RRC reconfiguration message including a configuration of one or more candidate target cells associated with LTM, to transmit, to the base station, a RRC reconfiguration complete message, to transmit, to the base station, a report for a L1 measurement associated with the one or more candidate target cells, and to receive, from the base station, a cell switch command message associated with the LTM, via MAC-CE signaling, wherein the cell switch command message includes random access information on a target cell.

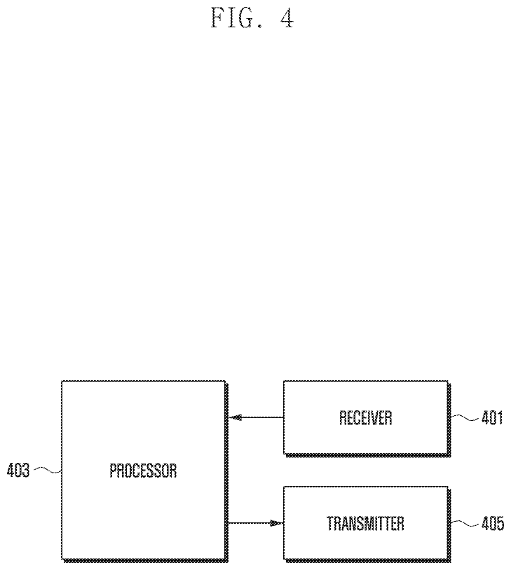

FIG. 4 illustrates a block diagram of a base station according to an embodiment of the disclosure.

Referring to FIG. 4, the base station includes a receiver 401, a transmitter 405, and a processor 403. The receiver 401 and the transmitter 405 may commonly be referred to as a transceiver. The transceiver may transmit and receive a signal to and from the UE. The signal may include control information and data. To this end, the transceiver may include an RF transmitter that up-converts and amplifies the frequency of a transmitted signal, an RF receiver that low-noise amplifies a received signal and down-converts the frequency, etc. Further, the transceiver may receive a signal through a wireless channel, output the signal to the processor 403, and transmit the signal output from the processor 403 through a wireless channel.

The processor 403 may control a series of processes so that the base station operates according to embodiments of the disclosure. For example, the processor 403 controls operations of the base station according to the above-described embodiment of the disclosure. The processor 403 is configured to transmit, to a UE, a RRC reconfiguration message including a configuration of one or more candidate target cells associated with LTM, to receive, from the UE, a RRC reconfiguration complete message, to receive, from the UE, a report for a L1 measurement associated with the one or more candidate target cells, and to transmit, to the UE, a cell switch command message associated with the LTM, via MAC-CE signaling, wherein the cell switch command message includes random access information on a target cell.

According to an embodiment of the disclosure, the number of radio link failures can be reduced by performing a cell change based on the LTM.

Further, according to an embodiment of the disclosure, time for configuring a target cell can be reduced.

Further, according to an embodiment of the disclosure, configurations associated with a random access procedure can be determined, when a UE performs the random access procedure triggered by the LTM.

Effects that can be obtained in the disclosure are not limited to the above-described effects, and other unmentioned effects will be able to be clearly understood by those of ordinary skill in the art to which the disclosure pertains.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a RAM and a flash memory, a ROM, an electrically erasable programmable read only memory (EEPROM), a magnetic disc storage device, a CD-ROM, DVDs, other type optical storage devices, or a magnetic cassette. Alternatively, any combination of some or all of the memory devices may form a memory in which the program is stored. Further, a plurality of such memories may be included in the electronic device.

In addition, the programs may be stored in an attachable storage device which may access the electronic device through communication networks such as the Internet, Intranet, a local area network (LAN), a wide LAN (WLAN), and a storage area network (SAN) or a combination thereof. Such a storage device may access the electronic device via an external port. Further, a separate storage device on the communication network may access a portable electronic device.

The embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other modifications and changes may be made thereto on the basis of the technical idea of the disclosure. Further, the above respective embodiments may be employed in combination, as necessary. For example, one embodiment of the disclosure is partially combined with other embodiments to operate a BS and a UE. As an example, embodiments of the disclosure described herein may be combined with each other to operate a BS and a UE.

In the drawings in which methods of the disclosure are described, the order of the description does not always correspond to the order in which steps of each method are performed, and the order or relationship between the steps may be changed or the steps may be performed in parallel.

Alternatively, in the drawings in which methods of the disclosure are described, some elements may be omitted and only some elements may be included therein without departing from the essential spirit and scope of the disclosure.

Further, in methods of the disclosure, some or all of the contents of each embodiment may be combined without departing from the scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station of a serving cell, a radio resource control (RRC) reconfiguration message comprising a configuration of one or more candidate target cells associated with layer 1 (L1) or layer 2 (L2) triggered mobility (LTM);
transmitting, to the base station, a RRC reconfiguration complete message;
transmitting, to the base station, a report for a L1 measurement associated with the one or more candidate target cells; and
receiving, from the base station, a cell switch command message associated with the LTM, via medium access control-control element (MAC-CE) signaling,
wherein the cell switch command message comprises random access information on a target cell.

2. The method of claim 1, further comprising:
initiating a random access procedure towards the target cell based on the cell switch command message triggering to a change from the serving cell to the target cell.

3. The method of claim 2, wherein in case that a timing advance is maintained for the target cell and a time alignment timer associated with the target cell is not running, the random access procedure is initiated.

4. The method of claim 2, wherein the cell switch command message further indicates synchronization signal block (SSB) information, a preamble index, and a random access occasion mask index for the random access procedure.

5. The method of claim 4, wherein initiating the random access procedure comprises:
selecting an uplink (UL) carrier for the random access procedure;
selecting a synchronization signal block (SSB) based on the SSB information and a preamble corresponding to the preamble index;
selecting a random access channel occasion (RO) corresponding to the SSB from ROs configured by the RRC reconfiguration message; and
transmitting, to the target cell, the preamble in selected RO.

6. The method of claim 5,
wherein the cell switch command message further comprises information indicating the UL carrier,
wherein, in case that the information indicating the UL carrier indicates a supplementary UL (SUL) carrier, the SUL carrier is selected as the UL carrier, and
wherein, in case that the information indicating the UL carrier indicates a normal UL (NUL) carrier, the NUL carrier is selected as the UL carrier.

7. A method performed by a base station of a source cell in a wireless communication system, the method comprising:
transmitting, to a user equipment (UE), a radio resource control (RRC) reconfiguration message comprising a configuration of one or more candidate target cells associated with layer 1 (L1) or layer 2 (L2) triggered mobility (LTM);
receiving, from the UE, a RRC reconfiguration complete message;
receiving, from the UE, a report for a L1 measurement associated with the one or more candidate target cells; and
transmitting, to the UE, a cell switch command message associated with the LTM, via medium access control-control element (MAC-CE) signaling,
wherein the cell switch command message comprises random access information on a target cell.

8. The method of claim 7, wherein a random access procedure towards the target cell is initiated based on the cell switch command message triggering to a change from a serving cell to the target cell.

9. The method of claim 8, wherein in case that a timing advance is maintained for the target cell and a time alignment timer associated with the target cell is not running, the random access procedure is initiated.

10. The method of claim 8, wherein the cell switch command message further comprises:
information indicating an uplink (UL) carrier for the random access procedure,
synchronization signal block (SSB) information,
a preamble index, and
a random access occasion mask index for the random access procedure.

11. A user equipment (UE) in a wireless communication system, the UE comprising:
a transceiver; and
a processor coupled with the transceiver and configured to:
receive, from a base station of a serving cell, a radio resource control (RRC) reconfiguration message comprising a configuration of one or more candidate target cells associated with layer 1 (L1) or layer 2 (L2) triggered mobility (LTM),
transmit, to the base station, a RRC reconfiguration complete message,
transmit, to the base station, a report for a L1 measurement associated with the one or more candidate target cells, and
receive, from the base station, a cell switch command message associated with the LTM, via medium access control-control element (MAC-CE) signaling,
wherein the cell switch command message comprises random access information on a target cell.

12. The UE of claim 11, wherein the processor is further configured to:
initiate a random access procedure towards the target cell based on the cell switch command message triggering to a change from the serving cell to the target cell.

13. The UE of claim 12, wherein the cell switch command message further comprises:
information indicating an uplink (UL) carrier for the random access procedure,
synchronization signal block (SSB) information,
a preamble index, and
a random access occasion mask index for the random access procedure.

14. A base station of a source cell in a wireless communication system, the base station comprising:
a transceiver; and
a processor coupled with the transceiver and configured to:
transmit, to a user equipment (UE), a radio resource control (RRC) reconfiguration message comprising a configuration of one or more candidate target cells associated with layer 1 (L1) or layer 2 (L2) triggered mobility (LTM),
receive, from the UE, a RRC reconfiguration complete message,
receive, from the UE, a report for a L1 measurement associated with the one or more candidate target cells, and
transmit, to the UE, a cell switch command message associated with the LTM, via medium access control-control element (MAC-CE) signaling,
wherein the cell switch command message comprises random access information on a target cell.

15. The base station of claim 14,
wherein a random access procedure towards the target cell is initiated based on the cell switch command message triggering to a change from a serving cell to the target cell, and
wherein the cell switch command message further comprises:
information indicating an uplink (UL) carrier for the random access procedure,
synchronization signal block (SSB) information,
a preamble index, and
a random access occasion mask index for the random access procedure.
